(19) United States
(12) Patent Application Publication
(10) Pub. No.: US 2005/0227053 A1
(43) Pub. Date: Oct. 13, 2005

(54) Anti-reflection film comprising conductive polymer layer and producing method thereof

(75) Inventors: Jin Yeol Kim, Kyunggi-do (KR); Hironobu Shinihara, Tokyoda (JP)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5514, US

(73) Assignee: Naoenics, Inc.

(21) Appl. No.: 10/821,062

(22) Filed: Apr. 7, 2004

(51) Int. Cl. B32B 7/02

(52) U.S. Cl. 428/212; 428/913

(57) ABSTRACT

The present invention relates to an anti-reflection film for preventing the reduction of image quality caused by light reflection in various display screens, such as CRT, liquid crystal displays (LCD) and plasma display panels (PDP). The anti-reflection film 100 comprises a substrate consisting of a transparent polymer film 110, and at least one conductive polymer layer 120 formed by depositing a heterocyclic conjugated polymer on at least one surface of the substrate. Thus, the inventive anti-reflection film has high transparency and small thickness, and anti-static and/or electromagnetic shielding properties, such that it can be widely used in electrical, mechanical and electronic fields.

### BACKGROUND OF THE INVENTION

1. Field of the Invention

The present invention relates to an anti-reflection film, and more particularly, to an anti-reflection film of preventing a reduction in image quality caused by light reflection in various display screens, such as CRT, a liquid crystal display (LCD) and a plasma display panel (PDP), as well as a method for producing the same.

2. Background of the Related Art

With the development of battery and electronic industries and the enhancement of an information and communication society, the requirement for high definition and high quality in the field of electronic display (CRT, LCD and PDP) is also being increased. The greatest problem with such electronic displays is a reduction in image quality caused by light reflection, and another problem is that contaminants are easily attached to a display or monitor surface due to electrostatic discharge and that electromagnetic waves generated from the displays can influence the human body and other indoor electronic devices. To avoid such problems, in the prior art, there were used various methods, including a method where a plastic film having both anti-reflection function and electrostatic discharge/electromagnetic wave shielding function is either attached directly on the display screen or placed within the display.

In the optical industry, a theory for anti-reflection coating where the surface of an object is deposited with several thin film layers having a different refractive index to quench reflection light reflected from the surface has been known long ago. This theory was difficult to apply to practical products due to the absence of thin film formation technology. But since 1940's, as vacuum deposition and sputtering techniques were commercially used, it has been used in various applications.

With regard to the formation of an anti-reflection layer on a plastic substrate, there are known methods where a high refractive inorganic material having high refractive index, such as indium tin oxide (ITO), TiO₂ or ZrO₂, and a low refractive inorganic material having low refractive index, such as SiO₂ or MgF₂, are alternately deposited in at least four layers by the vacuum deposition or sputtering technique (U.S. Pat. Nos. 5,744,227 and 5,783,049, and Japanese Patent Laid-Open Publication Nos. Hei 5-307104, Hei 8-82701, 9-197103, and Hei 9-197102). This anti-reflection film formed by the vacuum deposition or sputtering technique shows excellent anti-reflection performance, but this technique has problems in that it has low productivity and high production cost due to a slow process speed of about 1 m/min and also it causes damage to the plastic substrate since it is conducted at high vacuum and temperature. On the other hand, a method for forming a fluorinated polymer film with a low refractive index as an anti-reflection film only by wet coating (Japanese Patent Laid-Open Publication Nos. Hei 6-230201 and Hei 9-203801) is known to produce a film with inferior anti-reflection performance. However, this process shows increased productivity because of high process speed.

A low reflection film comprising a transparent polymer film having anti-reflection function has been widely used in electronic, electrical and mechanical fields. Particularly, when the low reflection film is used in displays, including liquid crystal display panels and plasma display panels, it can reduce light reflectivity to allow a more distinct image to be displayed.

Generally, the low reflection film has been produced by either a method where inorganic oxide, such as SiO₂, TiO₂ or indium tin oxide (ITO), is deposited on a transparent polymer resin film, such as a polyester, triacetate cellulose or polycarbonate film, by a sputtering or deposition technique, to form a multi-layered thin film having at least four layers, or a method where a fluorine-containing compound is wet-coated on the polymer transparent film to form an anti-reflection film or low-reflection film.

However, when the multi-layered anti-reflection film is produced by the sputtering or deposition technique, there is no problem of a reduction in optical transparency caused by coloring, etc., but processing cost is increased to cause a great increase in production cost. Furthermore, when the anti-reflection layer is formed of only a material such as SiO₂ or TiO₂, it has no anti-static function so that it is exposed to electrostatic discharge and easily attached with dust, etc, and thus, it surface is easily contaminated. For this reason, there was used a method for preventing electrostatic discharge, where an ITO layer as a transparent conductive inorganic oxide layer is separately formed, or an anti-static agent is added as a separate layer, to form an anti-static layer at the surface.

Recently, with the rapid growth of the flat panel display industry, the use of the anti-reflection film shows a tendency to widen, and thus, the discovery of a new material to reduce production cost became an important research target.

For the transparent conductive layer that is used in a film for displays, indium tin oxide (ITO) is frequently used but very expensive. Recently, various efforts to substitute for ITO are progressed. A typical example thereof is forming an anti-static layer of a conductive layer by a wet coating technique, in which case there are various known problems in that the film thickness is difficult to be controlled, the film transparency is reduced, coloring easily occurs, and the anti-static agent often permeates out of the surface.

Meanwhile, heterocyclic conductive polymers such as polypyrrole and polythiophene are recently known as a new material which is synthesized relatively easily, and has high electrical conductivity and shows stable physical properties even in the atmosphere. Thus, many studies related thereto are being conducted.

Methods that are known as being used for the synthesis of the conductive polymer include chemical oxidative polymerization and electrochemical polymerization. However, the conductive polymer has a shortcoming in that it is not molten or dissolved to make it difficult to process the polymer in a film form. Thus, the polymer synthesized by the chemical oxidative polymerization has a particle form to make it difficult to form a thin film, and the polymer synthesized by the electrochemical polymerization is also difficult to be formed into a thin film at a continuous process and also has low mechanical strength, so that they encounter many limitations in their practical application.

In an attempt to solve such problems, there was recently proposed a method wherein the conductive polymer in a particle form is mixed with general polymer to make a composite material having improved processability and physical properties, and then coated on a film substrate to impart anti-static function. However, a large amount of a mixed resin is required to impart sufficient adhesion, in which the resin has a problem in that it causes a great deterioration in the properties of the conductive polymer. Also, even if the composite material is coated on the polymer resin film to impart anti-static function, the coated layer has a large thickness of about several microns so that it reduces the transparency of the film and encounters limitations in use for a multi-layered thin film whose thickness should be controlled to a fine level. Furthermore, in this case, there is a shortcoming in that a several-step process is required to obtain a final film.

### SUMMARY OF THE INVENTION

The present inventors have conducted intensive studies to solve the problems with the prior anti-reflection film, such as the reduction in physical properties and the complexity in production process, and consequently, developed a method of depositing a heterocyclic conjugated polymer on the surface of a transparent polymer film as a substrate, and using this method, produced a conductive layer for a low reflection film for optical application, and also a new material of controlling even a refractive index. On the basis of this point, the present invention was perfected.

Accordingly, an object of the present invention is to provide an anti-reflection film having both anti-static function and low reflection function, and a producing method thereof, in which a conductive polymer layer in thin film form, which has high transparency and whose thickness can be controlled to the nano level, is formed on a substrate.

To achieve the above object, in one aspect, the present invention provides an anti-reflection film comprising: a substrate consisting of a transparent polymer film, and at least one conductive layer formed by depositing a heterocyclic conjugated polymer of the following structural formula (1) on at least one surface of the substrate: 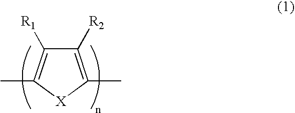
wherein X represents O, Se, S or NH; and R₁ and R₂, which may be the same or different, each independently represents H, a C₃-C₁₅ alkyl group, a C₃-C₁₅ alkylether group, an halogen atom, or a substituent which forms a cyclic structure while containing hydrocarbon together with at least one atom selected from the group consisting of S and O.

In another aspect, the present invention provides a method for producing an anti-reflection film, the method comprising the steps of: applying an oxidizing agent on at least one surface of a substrate consisting of a transparent polymer film; and subjecting a heterocyclic conjugated monomer of the structural formula (1) to vapor phase polymerization on the substrate applied with the oxidizing agent and then removing an unreacted portion of the oxidizing agent, thereby forming at least one conductive layer made of the resulting heteocyclic conjugated polymer of the structural formula (1).

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic diagram of an anti-reflection and anti-static film formed by depositing a conductive polymer layer, according to one embodiment of the present invention;

FIGS. 2 to 5 are schematic diagrams showing other structures of an anti-reflection and anti-static film formed by depositing a conductive polymer layer, according to other embodiments of the present invention;

FIG. 6 is a block diagram showing a producing process of the anti-reflection and anti-static film shown in FIG. 2; and

FIG. 7 is a block diagram showing a producing process of the anti-reflection and anti-static film shown in FIG. 3.

### DETAILED DESCRIPTION OF THE PREFERRED EMBODIMENT

Hereinafter, an anti-reflection film formed by depositing a conductive polymer layer, according to preferred embodiments of the present invention, and a producing method thereof, will be described in detail with reference to the accompanying drawings.

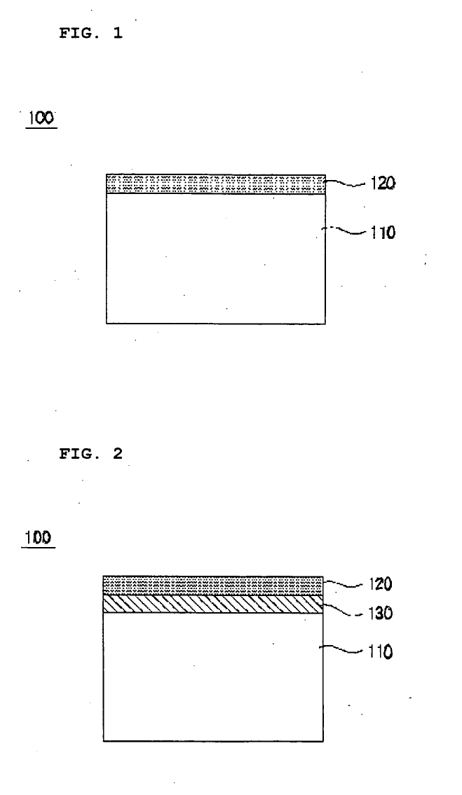

FIG. 1 is a schematic diagram of an anti-reflection, anti-static film formed by depositing a conductive polymer, according to one embodiment of the present invention. As shown in FIG. 1, an anti-reflection film 100 of the present invention comprises a transparent polymer film 110 as a substrate. On the surface of the substrate, a heterocyclic conjugated polymer which is produced by vapor phase polymerization is deposited to form a conductive polymer layer (hereinafter, referred to as “conductive layer”) 120. Thus, the anti-reflection, anti-static film 100 has small thickness and shows anti-static and electromagnetic shielding properties.

The transparent polymer film 110 which is used as the substrate in the present invention is a film that has been conventionally used, and its examples include a polyester film, such as a polyethylene terephthalate, polybutylene terephthalate or polyethylene napththalate film, and polyethylene, polypropylene, cellophane, diacetylcelloulse, triacetate cellulose, acetylcellulose butyrate, polyvinyl chloride, polyvinyl alcohol, polystyrene, polyethylene-acetic acid, polyvinylidene chloride, polycarbonate, polyacrylic, polymethylpentene, polysulfone, and polyamide films. The transparent polymer film preferably has a possible higher transparency and a visible light transmittance of 75-92%. Namely, the transparent polymer film that is used in the production of the low reflection film should generally have a visible light transmittance of 75-92%. Furthermore, the transparent polymer film preferably has a thickness of 10-1,000 μm, and more preferably 20-200 μm.

The polymer that is used for the formation of the conductive layer in the present invention is a heterocyclic conjugated polymer, and particularly a heterocyclic conjugated polymer containing an oxygen (O), selenium (Se), nitrate (NH) or sulfur (S) atom. More preferably, pyrrole, thiophene, furan, selenophene and their derivatives, which are represented by the following structural formula (1), may be more preferably used as the heterocyclic conjugated polymer in the present invention: 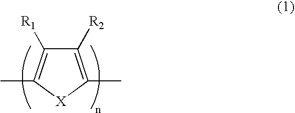
wherein X represents O, Se, S or NH; and R₁ and R₂, which may be the same or different, each independently represents H, a C₃-C₁₅ alkyl group, a C₃-C₁₅ alkylether group, an halogen atom, or a substituent which forms a cyclic structure while containing hydrocarbon together with at least one atom selected from the group consisting of S and O.

In present invention, the anti-reflection film or low-reflection is produced by a method comprising: producing a heterocyclic conjugated monomer vapor of the structural formula (1); and inducing the vapor phase polymerization of the produced monomer on the surface of the transparent polymer film substrate to form the conductive layer on the surface of the substrate by the vapor polymerization. However, the present invention is not limited only to this method. Namely, in producing the anti-reflection film 100 according to the present invention, the heterocyclic conjugated polymer of the structural formula (1) is deposited on at least one surface of the transparent polymer film substrate 110 so as to form the conductive layer 120 on the substrate of the film substrate. Thus, the resulting anti-reflection film 100 has both anti-static function and low reflection function.

The inventive anti-reflection film as described above has the following characteristics: a conductive layer thickness of 10-1,000 nm, a visible light transmittance of 60-90%, a sheet resistance of 10²-10⁹ Ω/sq, and a refractive index of 1.0-1.54. Such characteristics were obtained in the part “measuring method of physical properties” to be described later.

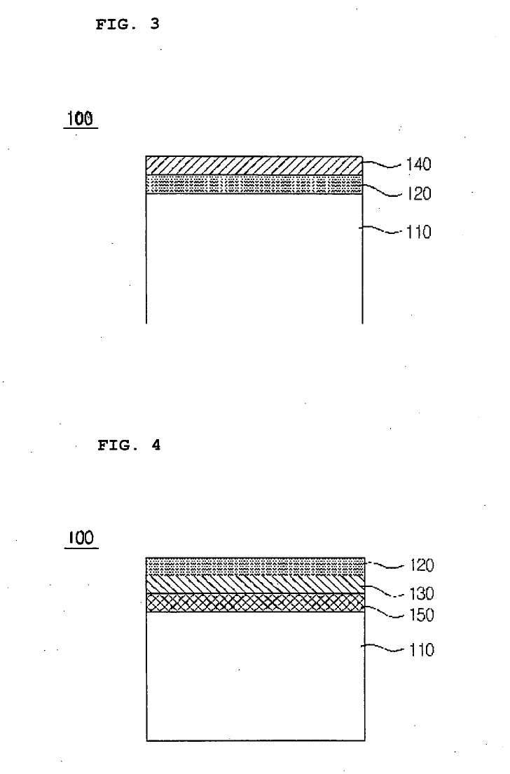

The anti-reflection film of the present invention can have a more preferable structure than the above-mentioned structure. The more preferable structure is shown in FIG. 2, in which a thin film layer 130 having a higher refractive index than the conductive layer 120 is formed between the transparent polymer film 110 and the conductive layer 120, such that the low reflection function can be improved as compared to the structure of FIG. 1. In this case, the high refractive layer 130 is formed of a high molecular compound or TiO₂ having a higher refractive index than the conductive layer 120. In another embodiment, another structure of the anti-reflection film 100 of the present invention is shown in FIG. 3, in which a thin film layer 140 having a lower refractive index than the conductive layer 120 is formed on at least on surface of the transparent polymer film 110, so that the low reflection function can be further improved. In this case, the thin film layer 140 having low refractive index can be formed of a fluorine-based polymer compound or SiO₂ which has a lower refractive index than the conductive layer 120. FIGS. 2 and 3 are schematic diagrams each showing another structure of the inventive anti-reflection film comprising the conductive polymer layer deposited thereon.

In still another embodiment, another structure of the anti-reflection and anti-static film 100 of the present invention is shown in FIG. 4, in which a hard coating layer 150 is formed between the high refractive layer 130 deposited as shown in FIG. 2 and the transparent polymer film 110. This hard coating layer 150 serves to enhance the surface strength of the transparent polymer film 110 to prevent surface scratching. In this case, the hard coating layer 150 is preferably made of a heat-curable resin or a UV-curable acrylic resin. In further another embodiment, another structure of the anti-reflection film 100 of the present invention is shown in FIG. 5, in which the low refractive thin film layer 140 is formed on the conductive layer 120 deposited as shown in FIG. 4. FIGS. 4 and 5 are schematic diagrams each showing another structure of the inventive anti-reflection and anti-static film comprising the conductive polymer deposited thereon.

The high refractive thin film layer 130, the low refractive thin film layer 140 and the hard coating layer 150 are formed by conventional methods that are widely known in the art.

Also, the present invention relates to a producing method of the anti-reflection and anti-static film. Hereinafter, a description of the producing method will be provided in detail with reference to a multi-layered film consisting of the conductive layer and other functional layers on the polymer film substrate.

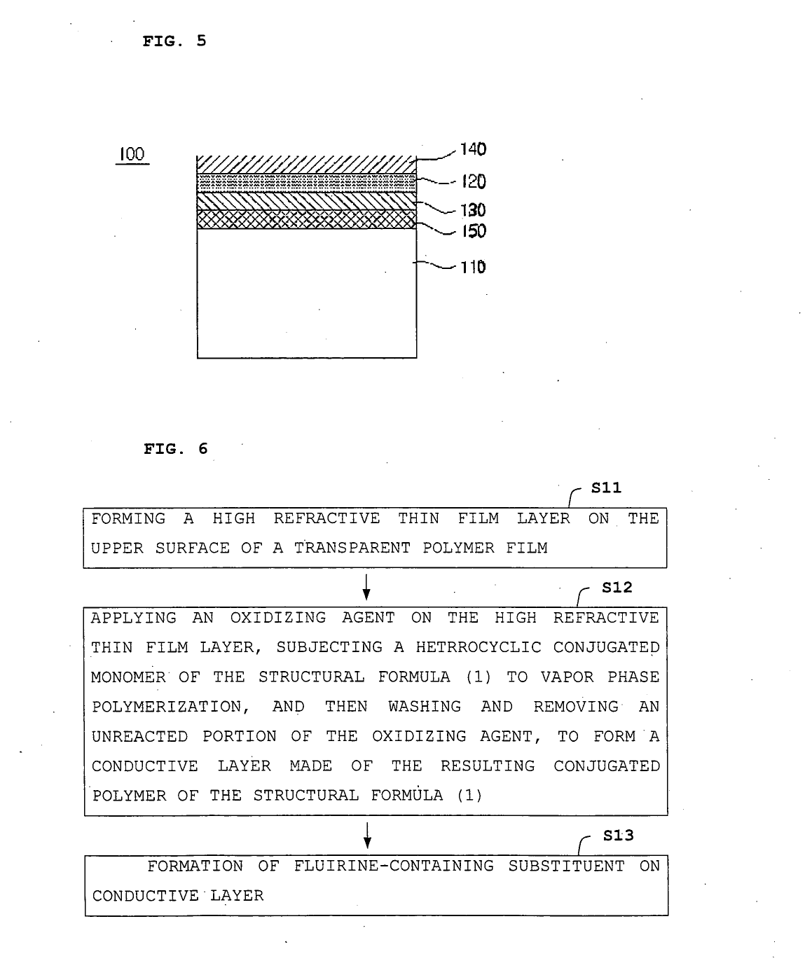

FIG. 6 is a block diagram showing a producing method of the inventive anti-reflection film shown in FIG. 2. As shown in FIGS. 2 and 6, the transparent polymer film 110 is first coated with a solution having a higher refractive index than the polymer of the structural formula (1), and then dried, to form the high refractive thin film layer 130 (S11). Thereafter, an oxidizing agent is applied on the upper surface of the high refractive thin film layer 130. Next, a conjugated monomer of the structural formula (1) is subjected to vapor phase polymerization on the surface of the thin film layer 130, and then, an unreacted portion of the oxidizing agent is removed by washing, to form the conductive layer 120 made of the resulting conjugated polymer of the structural formula (1) (S12).

In forming the conductive layer on the film substrate or the functional thin film layer according to the present invention, a Lewis acid such as Cu(ClO₄).6H₂O or FeCl₃ can be used as the oxidizing agent. The oxidizing agent is dissolved in one or two solvents selected from polar organic solvents, and preferably alcohols, before use. If necessary, the oxidizing agent may also contain a polymer, such as polyurethane, polyvinyl chloride, polyvinyl alcohol, methyl cellulose or chitosan, as a binder resin, at the amount of 1-20 weight parts (based on solid content) relative to one weight part of the oxidizing agent. If this polymer is used at less than one weight part, it will have no function as the binder, whereas if it is used at more than 20 weight parts, it will cause a reduction in conductivity. Since the polymer added to the oxidizing agent shows a high affinity for the heterocyclic conjugated monomer depending on its content, it is suitable as a host polymer in the vapor phase polymerization for the formation of the conductive layer. However, if a host polymer is used, it can cause a reduction in the physical properties of the conductive polymer material itself. Particularly, it can be difficult to control a refractive index.

Thereafter, if necessary, a coating solution containing a fluorine substituent functioning to prevent contamination is coated on the upper surface of the conductive layer 120 to a thickness smaller than one micron, to produce a three-layered structure. In this case, the coated layer (not shown) containing the fluorine substituent with contamination prevention function preferably has a lower refractive index than the conductive layer 120, and allows anti-reflection performance to be further improved (S13).

Examples of a vapor phase polymerization process, that can be used for the formation of the conductive layer, include a process of distilling the monomer within a closed chamber at a temperature of 10 to 100° C., and a process using chemical vapor deposition (CVD). The thickness of the conductive layer formed by the vapor phase polymerization can be controlled in a range of 10-1,000 nm. Namely, forming the conductive layer to a thickness smaller than 10 nm will encounter a difficulty in view of current technology, and if the conductive layer is formed to a thickness larger than 1,000 nm, the desired effects of the present invention will not be achieved since it is too thick. Upon the end of this vapor phase polymerization, the resulting film is washed with solution, such as alcohols or water, to removes unreacted substances. However, the method for forming the conductive layer by the vapor phase polymerization is not limited only by the above-described method.

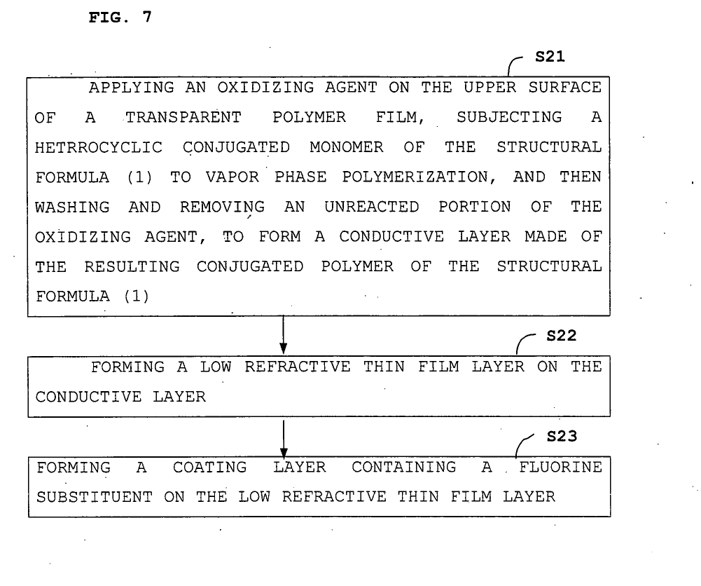

FIG. 7 is a block diagram showing a producing method of the inventive anti-reflection film shown in FIG. 3. As shown in FIGS. 3 and 7, the polymer of the structural formula (1) is deposited on the transparent polymer film 110 by vapor phase polymerization, to form the conductive layer 120 (S21). At this time, the conductive layer 120 is formed in the same manner as described above, using the oxidizing agent and/or the host polymer. Thereafter, a solution having a lower refractive index than the conductive layer 120 is formed on the resulting structure and dried, to form the low refractive thin film layer 120 (S22). If necessary, a coating layer containing a fluorine substituent with contamination prevention function is then formed in the same manner as described above (S23).

The present invention will hereinafter be described in further detail by examples and comparative examples. It should however be borne in mind that the present invention is not limited to or by the examples.

### Example 1

First, ferric chloride (FeCl₃) was dissolved in methyl alcohol solvent at a concentration of 2% by weight to produce an oxidizing agent solution. Then, the oxidizing agent solution was spin-coated on a polyethylene terephthalate (PET) film having a 1-88 μm thickness, and dried at about 65° C. for 3 minutes. Then, within a CVD chamber where the production of a thiophene monomer had been induced, the light yellow-colored polyester film coated with the oxidizing agent was kept at 60° C. for 30 seconds. Next, the resulting film was washed with methanol solvent to remove an unreacted portion of the oxidizing agent. In this way, a transparent light blue-colored, conductive polythiophene film was formed, and the physical properties of the produced anti-reflection film are given in Table 1 below.

### Examples 2-4

Anti-reflection films of the present invention were produced using the same composition and method as Example 1 except that the reactions within the CVD chamber were conducted at 30 for 30 seconds, at 45° C. for 30 seconds, and at 55° C. for 5 minutes, respectively. The physical properties of the produced anti-reflection films are given in Table 0.1 below.

Measuring Method of Physical Properties

The physical properties of the inventive anti-reflection films produced in Examples 1-4 were measured by the following test method.

1) The thickness of the coated layer: measured with an electronic microscope.

2) Transmittance: measured with HP 8453 UV/VIS spectrophotometer (ASTM D 1003).

3) Sheet resistance: measured with four-point probe MP MCP-T 350 (DINS) (ASTM D 257).

4) Hardness: measured with a pencil hardness tester (ASTM D 3363-92a).

5) Reflectivity: measured at a degree of 5° using Shimadzu MPC-3100.

6) Film adhesion: measured with a cross hatch cutter (ASTM D 3359).

7) Thermal stability: measured with TGA 2050 (DuPont) at a heating rate of 10° C./min in a temperature range of 30-500° C.

TABLE 1

| | Thickness | Visible light | Sheet | | | |
|---|---|---|---|---|---|---|
| | (nm) of | transmittance | resistance | Reflectivity | | Thermal |
| | coated layer | (%) | (Ω/sq) | (%) | Film adhesion | stability |
| PET film | — | 88 | 10¹⁶ | 10 | — | — |
| Example 1 | 52 | 83 | 10⁴ | 7 | Excellent | Stable |
| Example 2 | 24 | 89 | 10⁶ | 8 | Excellent | Stable |
| Example 3 | 32 | 85 | 10⁵ | 8 | Excellent | Stable |
| Example 4 | 90 | 80 | 4,000 | 6 | Excellent | Stable |

As shown in Table 1 above, the anti-reflection films of Examples 1-4 for use in a display had greatly lower reflectivity and sheet resistance than the PET film as a substrate. Furthermore, the physical property values of the anti-reflection film of Example 4, produced by the reaction at 55° C. for 5 minutes, were lower than Example 1 (at 60° C. for 30 seconds), Example 2 (at 30° C. for 30 seconds) and Example 3 (at 45° C. for 30 seconds). From this fact, it could be found that the temperature and time of reaction influenced the physical properties of the anti-reflection film.

### Example 5

First, ferric chloride (FeCl₃) was dissolved in methyl alcohol solvent at a concentration of 3% by weight to produce an oxidizing agent solution. Then, the oxidizing agent solution was spin-coated on a corona-treated Arton film (manufactured by JSR corp.) having a 0.1 mm thickness, and dried at about 65° C. for 5 minutes. Then, within a CVD chamber where the production of a thiophene monomer had been induced, the Arton film coated with the oxidizing agent was kept at 60° C. for 30 seconds. Next, the resulting film was washed with methanol solvent to remove an unreacted portion of the oxidizing agent. In this way, a conductive polythiophene film was formed, and the physical properties of the produced anti-reflection film were measured as described in the part “measuring method of physical properties” and the results are given in Table 2 below.

TABLE 2

| | | Visible light | Sheet | | | |
|---|---|---|---|---|---|---|
| | Thickness of | transmittance | resistance | Reflectivity | | Thermal |
| | coated layer | (%) | (Ω/sq) | (%) | Film adhesion | stability |
| Arton film | — | 92 | 10¹⁶ | 7 | — | — |
| Example 5 | 48 | 88 | 5 × 10⁵ | 3.5 | Excellent | Stable |

As shown in Table 2 above, the inventive anti-reflection film (Example 5) produced using the corona-treated Arton film as a film substrate showed superior properties to the Arton film as a substrate.

### Examples 6-9

Anti-reflection films of the present invention were produced in the same manner as Example 1 except that pyrrole, thiophene, furan and selenophene were used as the heterocyclic conjugated monomer forming the conductive layer, and polymerized at 40° C. for 1 minute. The physical properties of the produced anti-reflection films were measured as described in the part “measuring method of physical properties” and the results are given in Table 3 below.

TABLE 3

| | | Thickness | Visible light | Sheet | | | |
|---|---|---|---|---|---|---|---|
| | Conductive | of coated | transmittance | resistance | Reflectivity | Film | Thermal |
| | layer | layer (nm) | (%) | (Ω/sq) | (%) | adhesion | stability |
| Example 6 | Polypyrrole | 80 | 75 | 5 × 10⁴ | 11 | Excellent | Stable |
| Example 7 | Polythiophene | 50 | 86 | 3 × 10³ | 8 | Excellent | Stable |
| Example 8 | Polyfuran | 45 | 81 | 8 × 10⁸ | 11 | Excellent | Stable |
| Example 9 | Polyselenophene | 60 | 80 | 7 × 10⁹ | 11 | Excellent | Stable |

Table 3 above shows the physical properties of the inventive anti-reflection films produced using different heterocyclic conjugated monomers. As shown in Table 3, the anti-reflection films produced in Examples 6-9 had a conductive layer thickness of 45-80 nm, a visible light transmittance of 75-80%, a sheet resistance of 7×10⁹ to 3×10⁹. Particularly, the anti-reflection film of Example 7 comprising the polythiophene layer showed excellent effects, including an excellent reflectivity of 8%.

As described above, the anti-reflection film of the present invention has high transparency, small thickness, and excellent anti-static and electromagnetic shielding properties, and thus, can be widely used in electrical, mechanical and electronic fields.

Furthermore, the method for producing the anti-reflection film according to the present invention has an effect in that a series of processes from the polymerization to the film production are possible such that production cost can be reduced.

While the anti-reflection film comprising the conductive polymer layer deposited thereon, and the producing method thereof, have been described with reference to the accompanying drawings, the description is intended to illustrate the most preferred embodiment of the present invention, and not to limit the present invention. Moreover, those skilled in the art will appreciate that various modifications, additions and substitutions are possible, without departing from the scope and spirit of the invention as disclosed in the accompanying claims.

1. An anti-reflection film comprising:
a substrate consisting of a transparent polymer film; and
at least one conductive layer formed by depositing a heterocyclic conjugated polymer of the following structural formula (1) on at least one surface of the substrate: 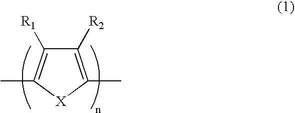
wherein X represents O, Se, S or NH; and R₁ and R₂, which may be the same or different, each independently represents H, a C₃-C₁₅ alkyl group, a C₃-C₁₅ alkylether group, an halogen atom, or a substituent which forms a cyclic structure while containing hydrocarbon together with at least one atom selected from the group consisting of S and O.

2. The anti-reflection film of claim 1, which additionally comprises a high refractive thin film layer between the substrate and the conductive layer, the high refractive thin film layer having a higher refractive index than the conductive layer.

3. The anti-reflection film of claim 2, which additionally comprises a hard coating layer between the substrate and the high refractive thin film layer, the hard coating layer serving to increase the surface hardness of the substrate.

4. The anti-reflection film of claim 1, which additionally comprises a low refractive thin film layer on the conductive layer, the low refractive thin film layer having a lower refractive index than the conductive layer.

5. The anti-reflection film of claim 3, which additionally comprises a low refractive thin film layer on the conductive layer, the low refractive thin film layer having a lower refractive index than the conductive layer.

6. A method for producing an anti-reflection film, which comprises:
a first step of applying an oxidizing agent on at least one surface of a substrate consisting of a transparent polymer film;
a second step of subjecting a heterocyclic conjugated monomer of the following structural formula (1) to vapor phase polymerization on the substrate applied with the oxidizing agent and then removing an unreacted portion of the oxidizing agent, thereby forming at least one conductive layer made of the resulting heteocyclic conjugated polymer of the structural formula (1): 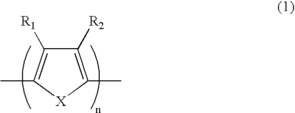
wherein X represents O, Se, S or NH; and R₁ and R₂, which may be the same or different, each independently represents H, C₃-C₁₅ alkyl, C₃-C₁₅ alkylether, an halogen atom, or a substituent which forms a cyclic structure while containing hydrocarbon together with at least one atom selected from the group consisting of S and O.

7. The method of claim 6, which additionally comprises forming a high refractive thin film layer having a higher refractive index than the conductive layer on the substrate, before the first step.

8. The method of claim 6, which additionally comprises forming a low refractive thin film layer having a lower refractive index than the conductive layer on the conductive layer, after the second step.

9. The method of claims 6, which additionally comprises adding a host polymer to the oxidizing agent.

10. The method of claims 7, which additionally comprises adding a host polymer to the oxidizing agent.

11. The method of claims 8, which additionally comprises adding a host polymer to the oxidizing agent.
